(19) United States
(12) Patent Application Publication
(10) Pub. No.: US 2014/0108114 A1
(43) Pub. Date: Apr. 17, 2014

(54) System for Providing Conditional User Awards

(71) Applicants: Harry Truong Mokm, Seattle, WA (US); Jie Tan, Tarrytown, NY (US)

(72) Inventors: Harry Truong MOKM, Seattle, WA (US); Jie Tan, Tarrytown, NY (US)

(21) Appl. No.: 13/919,280

(22) Filed: Jun. 17, 2013

Related U.S. Application Data
(63) Continuation of application No. 13/650,923, filed on Oct. 12, 2012.
(60) Provisional application No. 61/745,747, filed on Dec. 24, 2012.

(51) Int. Cl. G06Q 30/02

(52) U.S. Cl. CPC G06Q 30/0235
USPC 705/14.18; 705/14.1; 705/14.35; 705/14.19

(57) ABSTRACT

A long term goal oriented commercial promotion system is disclosed. A user is enabled to set up a trust account on the system to accumulate the financial incentives under the condition of a long term goal. The long term goal includes supporting college education, supporting retirement, staring a business, or patenting an innovation. A user performance includes various commercial activities required by a merchant.

### CROSS-REFERENCE

This is application claims the priority of the U.S. Provisional Application No. 61/745,747, filed on Dec. 24, 2012; and the priority of the continuation-in-part parent application of the U.S. application Ser. No. 13/650,923, filed on Oct. 12, 2012, and entirety of both applications are hereby incorporated by references.

### DESCRIPTION OF RELATED ART

The present application relates to a mobile system for alerting available Reward Programs to a user. More particularly, an electronic mobile device is enabled to be located and to be alerted with a commercial reward program in a local geographic area.

Note that the points discussed below may reflect the hindsight gained from the disclosed inventions, and are not necessarily admitted to be prior art.

The current Internet commerce and related communication systems are mostly based on client-server model where a cluster of central server systems and backend database systems are utilized to respond to client requests from internet users.

And based on this model, numerous computer based systems for promoting customer loyalty have been developed. These systems can be categorized into several groups. One such example is represented by ebay.com where customers get to bid on interested items for lower than usual prices. Another example is represented by amazon.com where some promotion may be dramatically discounted, or sales may be scheduled at an unconventional time to create a level of shopping excitement. Automatic incentives are provided when certain level of purchases are reached by individual customers. For example, a cash discount of $25 may be provided for having a $100 purchase. Another example is the “frequent flyer” programs implemented in the airline industry for promoting customers to stay with the same airline for traveling. The “name your own price” program exemplified by Priceline.com also helps promote good will among customers. All these systems are built on promoting individual shopping experiences and transactions.

INDOORATLAS™ location technology is partly inspired by evidence that animals use the Earth's magnetic field not only for orientation detection but also for true navigation. Some animals, such as spiny lobsters, are not only able to detect the direction of the Earth's magnetic field they can even sense their true position relative to their destination. This means these particular animals are able to derive positional information from local cues that arise from the local anomalies of the Earth's magnetic field. The INDOORATLAS™ technology can be found at http://web.indooratlas.com/web/WhitePaper.pdf. And the background information is attached with this Specification as Appendix A, the entirety of which is incorporated by reference.

Modern buildings with reinforced concrete and steel structures have unique, spatially-varying ambient magnetic fields that can be used for positioning, in much the same way (albeit on a much smaller spatial scale) as animals use the Earth's magnetic field. In principle, a non-uniform ambient magnetic field produces different magnetic observations, depending on the path taken through it.

In INDOORATLAS™ location technology, anomalies (fluctuations) of ambient magnetic fields are utilized in indoor positioning. This has been facilitated by modern smartphones and the rapid development of sensor technology. INDOORATLAS™ cloud-based location service is illustrated in FIG. 5B. The application uses the INDOORATLAS™ API to communicate with the INDOORATLAS™ location service. The API sends processed sensor data to the location service, which computes the current location estimate and delivers the estimate back to the application's event listener method through the API.

Facilitated by modern smartphones and the rapid development of sensor technology, INDOORATLAS™ has developed a completely new innovation that utilizes the anomalies of ambient magnetic fields for indoor positioning. INDOORATLAS™ offers a complete software toolbox for adding and managing floor plans, collecting data to create magnetic field maps, and an API to use INDOORATLAS™ location service for mobile applications. INDOORATLAS™ core technology is independent of external hardware infrastructures (such as radio access points) and is able to pinpoint the location inside a building within 0.1-2.0 meters.

By using the INDOORATLAS™ technology and services, the current invention provides indoor product promotions and incentive based programs.

### SUMMARY

This application discloses an innovative commercial promotion model for cash based consumer incentives and indoor commercial promotions.

In one embodiment, a computer based conditional award system (Conditional Award System) includes search engines, merchant management system, user management system and transaction engines that allow a user to set up accounts subject to self-imposed conditions and to accumulate cash incentives from merchant promotion activities under such self-imposed conditions. The merchant promotion activities include indoor commercial promotions and advertisements.

In one aspect of an embodiment, merchant users can set up incentive programs that offer direct cash deposits to a user in the system. Such programs are based on certain performance requirement or purchasing of specific products. Promotional products include searchable location information.

In one aspect of an embodiment of a plurality of computer processors, the system includes a mobile user interface that sends and receives digital data to a Conditional Award System wherein said digital data include a GPS or an INDOORATLAS™ location information; a search engine that conducts a search and retrieves information from a merchant Conditional Award Offers Database using said GPS or INDOORATLAS™ location information; a transaction engine that interacts with a merchant account database and a user account database, and performs transactions required to complete a Conditional Award Program.

In one aspect of an embodiment, computer processors include a merchant membership processor for creating member accounts for merchants and maintaining a merchant member account database; a merchant offered-reward processor which processes a reward to a customer from a merchant member and maintains a merchant conditional award offers database wherein said award is rewarded to the customer of the merchant for fulfilling a required customer activity, and said merchant award database being linked with said merchant member account database; a user membership processor for creating a user member account and maintaining a user member account database, wherein said user member account includes a long term goal-setting account for accumulating rewards; and a management processor for coordinating and channeling interactions between a merchant account, a user account and/or a system agent.

In one embodiment, a registered user is enabled to search incentive providing programs offered on the system, by key words, by personal information, and by incentive amount or by the most recent offers; is enabled to enter such programs with a single click.

In one embodiment, a financial incentive is automatically transferred to a registered user's piggy bank account upon a submission of a performance. And a piggy bank account statement is accessible to a user through cell phone or any internet access.

In one embodiment, a provider is enabled to post incentive programs to users directly on the system.

The disclosed innovation, in various embodiments, provides one or more of at least the listed advantages. However, not all of these advantages result from every one of the innovations disclosed, and this list of advantages does not limit the various claimed inventions.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example set of functional components for a Conditional Award System in accordance with this application.

FIG. 2 schematically shows an example set of transactions in a Conditional Award System in accordance with this application.

FIG. 3 schematically shows an example Registration for a merchant in a Conditional Award System in accordance with this application.

FIG. 4 schematically shows an example transactional process at a merchant side in a Conditional Award System in accordance with this application.

FIG. 5A schematically shows an example an example transactional process at a user side in a Conditional Award System in accordance with this application.

FIG. 5B schematically shows an example use of the INDOORATLAS™ technology and services.

FIG. 6 schematically shows an example mobile user interface at a user side in a Conditional Award System in accordance with this application.

FIG. 7 schematically shows an inside-store mobile user interface at a user side in a Conditional Award System in accordance with this application.

FIG. 8 schematically shows an outside-store mobile user interface at a user side in a Conditional Award System in accordance with this application.

FIG. 9 schematically shows an example architecture of an transaction engine in a Conditional Award System in accordance with this application.

FIGS. 10A and 10B schematically show an example mobile user interface in a Conditional Award System in accordance with this application.

FIG. 11 schematically shows an example Conditional Award Program in a Conditional Award System in accordance with this application.

FIG. 12 schematically shows an example User Piggy Bank Trust Account for a long term purpose in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

A “Component” is physical replacement part of the system that conforms to and provides an actual realization through a set of interfaces. It includes automated software virtualization interfaces that comprise all the source files, binary codes, executables, scripts that are packaged for performing the intended functions.

A “Subsystem” represents a combination of a package and a class. The package contains all the elements, including unique id elements, models, source files, html files, etc. that has one class that realizes these interfaces to the one unique package. For instance, in IT design terms; a subsystem is an interface user class represented as an actor symbol that (can) “extend” or “include” the live streaming media and data communication hub package.

“Engine” term in this application means a computer functional modular set of instructions programmed to complete a specific task, solve a problem, by instructing a computer processor.

“Method(s)” term means a method for object oriented programming code whereas it performs a subroutine and is exclusively associated with a class or an object. Normally, consists of a sequence of programming statements to perform an action, a set of parameters to customize those actions, and possibly an output value.

“Web-Service” is an application layer service that executes via a public internet interface and doesn't necessarily imply to a web site. A web service is one that can be located, discovered, and published via a network channel. Additionally, a web service can also act as an intermediary business application service agent that is an encapsulated service provider, but can also be a service requestor. This business service requestor can be a standalone piece of functionality. Normally, this type of service-agent acts as lightweight program executable that has a small memory footprint and can be custom developed. A “Web Service” generally means Services that are application oriented and encapsulate a business logic that executes an application as a business service.

For “Network Services”, there are two types. One type of “Network Services” mean file sharing services, file services, collaboration services, and messaging. They can also be located, discovered, and published. Another type of Network Service, taking the form of a Network Interface, implements a standard connection protocol, such as Ethernet, Wireless, etc.

A “User Performance” is a task-oriented performance required by a merchant, such activities may include an activity of purchasing.

A “Trust Account” is an account that is created by a trust agreement, with trustees and beneficiaries.

Similarly, the software elements of the present invention may be implemented with any programming or scripting language such as C, C++, Java, COBOL, assembler, PERL, or the like, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

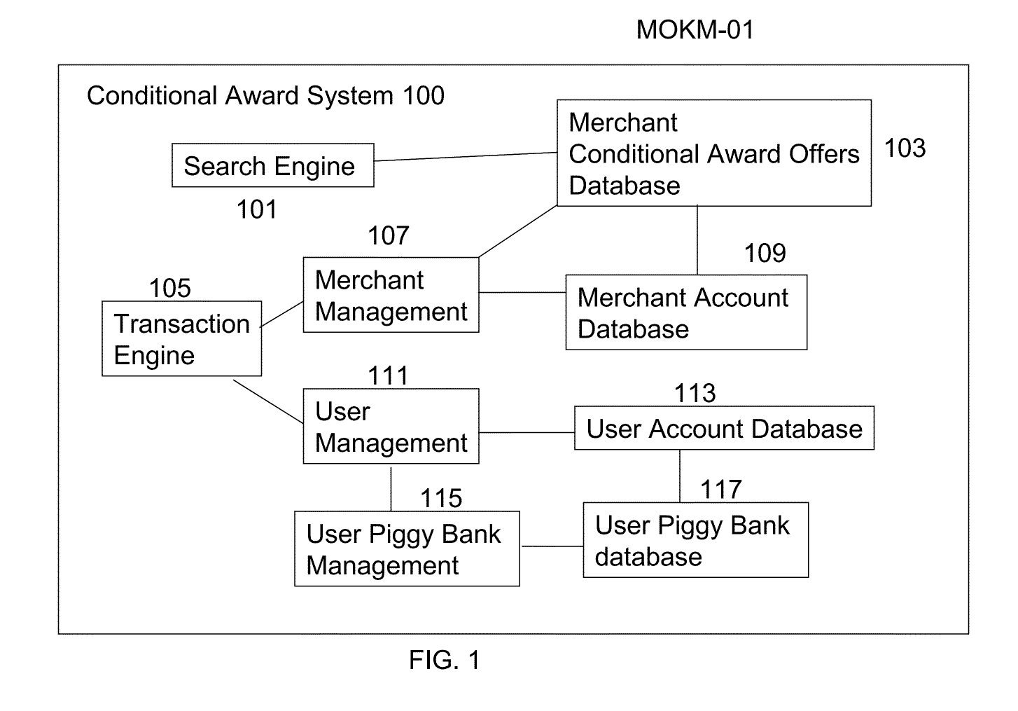

In reference to FIG. 1, a Conditional Award System (CAS) 100 includes a Search Engine component 101, a Merchant Conditional Award Program Database 103 for Conditional Award programs offered by various merchants, a Transaction Engine component 105 that includes a Merchant Management component 107 and a User Management component 111. Merchant Management component 107 provides management functions over a Merchant Account Database 109 and the Merchant Conditional Award Program database 103. User Management component 111 provides management functions to User Account Database 113 and User Piggy Bank Account Management 115 that in turn interacts with User Piggy Bank database 117. User Piggy Bank Account may be set up as a real bank account for real money, may be setup and managed by a bank or financial entity with such license or permits under any law and regulations. A Piggy Bank Account is a goal oriented Trust Account, payable for the purpose of achieving pre-set goals. Such goals may include for example paying college educations or retirement, financing a vacation, providing seed money for starting a business, and paying for patenting innovative ideas. Non-goal use of the account will encounter a penalty severe enough to discourage such use (for example, a 10% fee). Under circumstances, the Conditional Award System 100 can act as co-trustee for the Piggy Bank Accounts.

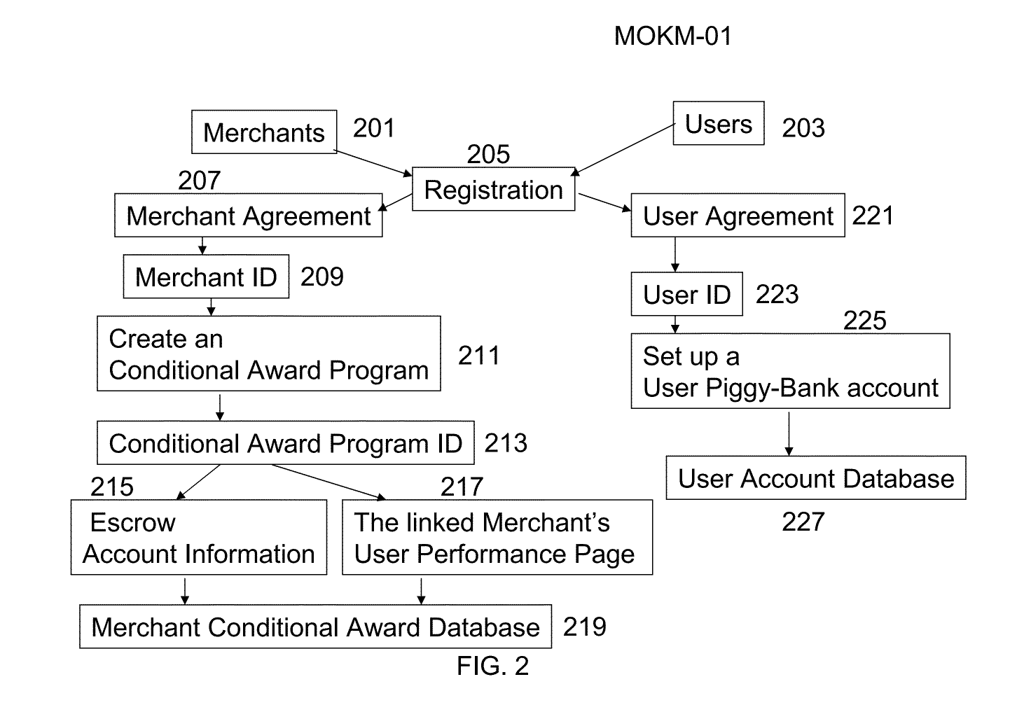

In reference to FIG. 2, an example registration process is shown, by which various functioning components of the CAS system are created and saved into the databases. For Merchants 201, at the system merchants web page, Merchant 201 goes through a Registration process 205 that inquires a number of information about the merchants identity, and creates a Merchant Agreement 207 and Merchant ID 209. Merchant Agreement 207 may require a merchant to promise or commit to set up an escrow account for financing the incentives it promises to provide through the program. The agreement allows the CAS system to act as a trustee to the Merchants escrow account to have the right to transfer the promised awards or incentives directly from a Merchant's escrow account to a user's Piggy Bank.

After receiving a Merchant ID, the merchant is prompted to create a Conditional Award Program at step 211 in the system that specifies the terms for receiving an award, for example, 10 cents for submitting a survey, 2 cents for a correct answer to a question, or a bonus 5 dollars for purchasing a product; 1 dollar for submitting a feedback for a product, 2 dollars for watching an advertisement, etc. The award can only be awarded after a user's successfully performing the specific tasks specified in the Conditional Award Program. In other wards, a user must earn the conditional award by performing a required task.

With a Conditional Award ID and a Merchant ID, the system then prompts the merchant to set up an escrow account or account information at step 215 to authorize the direct access by the CAS system, and link together the Award ID with the escrow account information. The system also prompts the merchant to link its Merchant's User Performance Web Page to the Conditional Award ID and CAS system at step 217 and Merchant Conditional Award Database 219, allowing a user to enter the Merchant's User Performance Page with a simple click in the CAS system. All the information is then saved into the Merchant Conditional Award Database 103, and also the Merchant Account Database 109 to track and record all the incentive based programs offered by a Provider.

A Merchant's User Performance Page may not be provided by the CAS system, may be implemented on the merchant's own internet service site using other content creating programs. While this arrangement would provide the maximum control to the Merchant to manage the content and the data that it wishes to collect, and that it is most suited to analyze, alternatively for the merchants who do not operate their own internet site, they may directly implement a User Performance Page on the CAS system using a Content Creating Engine provided by the CAS system.

For a User 203, it also goes through the general registration process of 205 by providing the identity information. A User Agreement 221 and a User ID 223 are then generated to authorize the system to be a trustee/co-trustee to set up a Piggy Bank Account for the user with a bank at step 225. The user is prompted to select a long term goal or aim for the Piggy Bank Account, among the example choices are: paying college educations or retirement, financing a vacation, providing seed money for starting a business, and paying for patenting innovative ideas. However, once a goal is set for a given Piggy Bank Account, the goal may not be changed without a penalty. Alternatively, the goal set for the Piggy Bank Account may be changed by paying a surcharge fee, such as 10-20% of the account amount. The user information and the associated Piggy Bank information are then saved into a User Account Database at step 227 for management by the system.

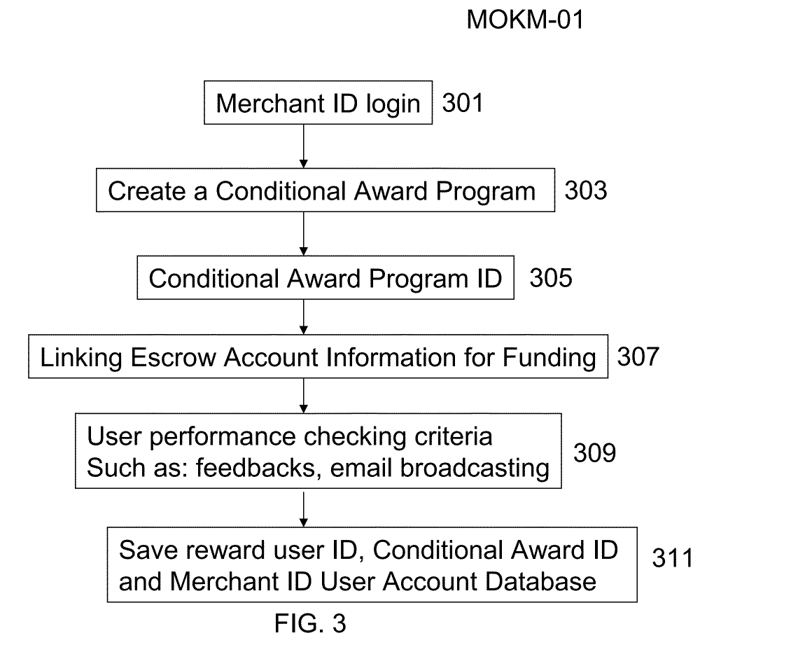

In reference to FIG. 3, for a registered Merchant, a process is shown to register a new Conditional Award Program under this merchant. A merchant is prompted to use its Merchant ID to login to the CAS system at step 301 to its merchant home page in the system. At step 303, a merchant can create a new Conditional Award Program by clicking on a New Program button on its home page. The program specifies the hierarchy of awards and the conditions for such awards. A Conditional Award Program ID is then provided at step 305, and the associated Escrow Account Information is provided and linked with the Program ID and accessing authorization is granted to the system at step 307. The merchant can also specify a number of filtering criteria for filtering the accesses to the Escrow Account by demanding upon certain satisfactions from a user's performance at step 309. And the information are saved to both Conditional Award Database and Provider Account Database at step 311.

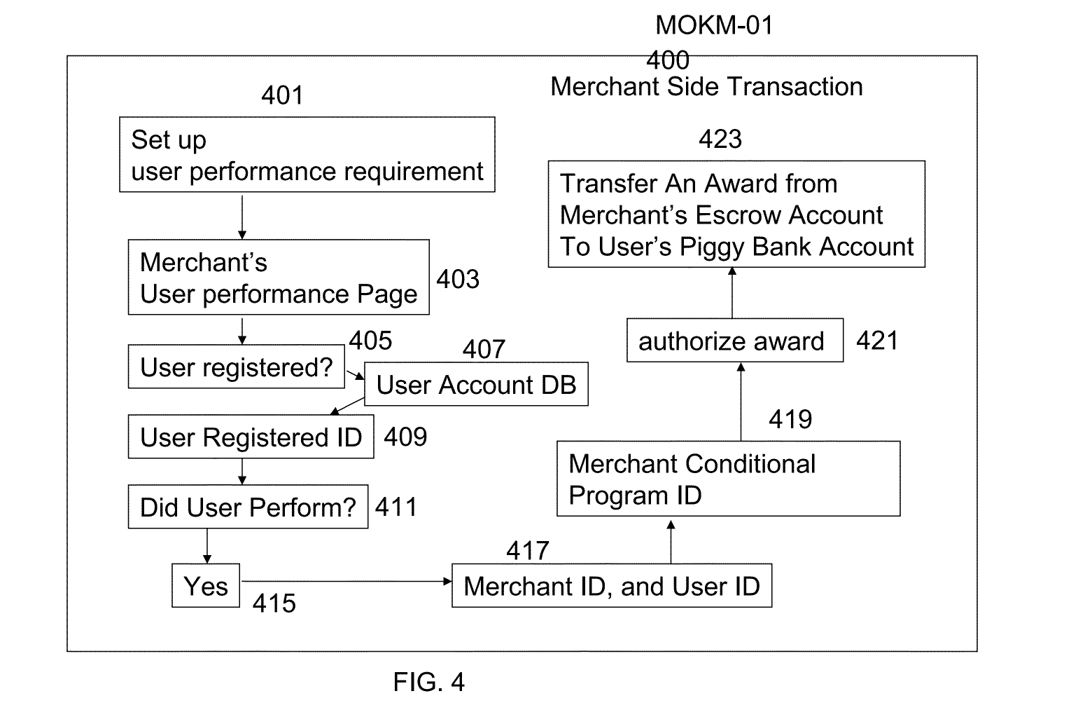

In reference to FIG. 4, a functional flow chart about the transactions 400 associated with a Merchant side. At step 401, a merchant that has set up a Conditional Award program with the CAS system may either set up a user performance requirement on its own service site or on the CAS system under the Conditional Award Program ID. At step 403, this requirement is then linked to the Merchant's User Performance Page on the Merchant's service site, or created on CAS system for the merchants who do not operate an internet site themselves. The User Performance Page provides details about the content and data that the merchant is requiring a User to perform.

Once a User performs and submits its performance from the User Performance Page at step 405, the User Performance Page at the Merchant site inquires the CAS system about the User's registration status at step 407 by prompting the User for User ID, and verifies from its User Account Database. If a User ID is not validated, the performance is temporally saved and the User is prompted to go to CAS registration to register for a User ID and to create a Piggy Bank Account. Once the User ID is validated at step 409, either the CAS system, or alternatively, the Merchant's User Performance Page checks whether the user has performed as required at step 411, and if the result is yes, the performance result is used to calculate the award at step 415 using the Award Program ID and the program. Then the Program ID, Merchant ID, and User ID are used to access the User Piggy Bank management engine at step 419, also the linked Escrow Account and the user Piggy Bank Account, and to authorize the transfer of the calculated award amount from the linked Escrow Account to the User Piggy Bank Account at step 421 and 423.

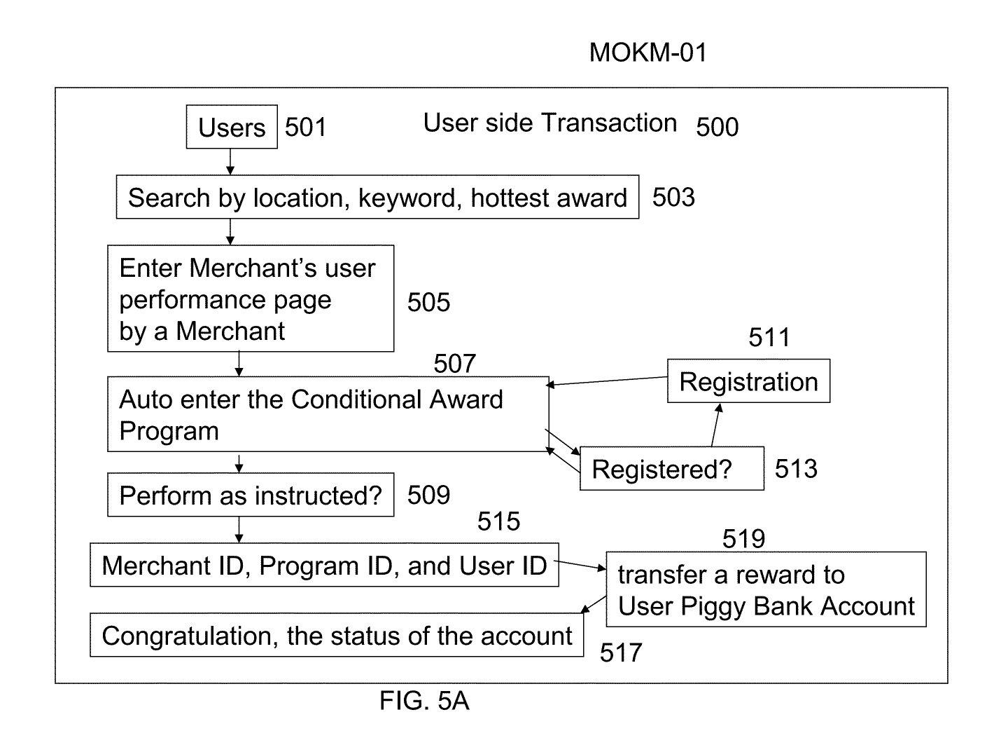

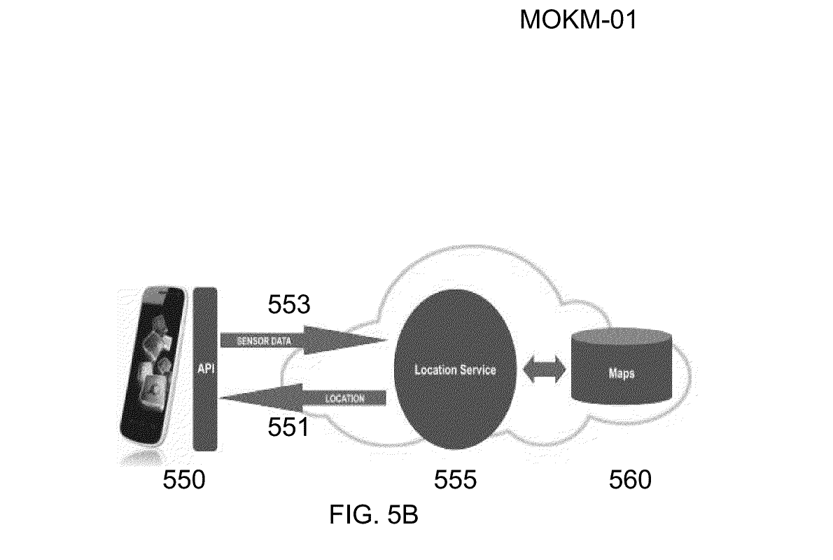

In reference to FIG. 5A, an example of User side transaction chains 500 is shown. A User at step 501 can search with the Search Engine of the CAS system, either online through the Internet, or with a cell phone application of the system, for an Award Program, according to its interest. The search may be conducted with key words, locations, hottest award programs, etc. At step 503, the User then selects a program of interest from the displayed Program lists with links and enters the Merchant's User Performance Page by clicking on the link at step 505. When the User submits the performance from the Merchant's User Performance Page, it automatically enters into the Conditional Award Program of the CAS system linked with the User Performance Page at step 507, and its registration status is then checked and validated through the Registration component at steps 509 and 511. If the User is not registered, it is prompted for registration. If it is a registered user, then the User ID is retained and the system checks the performance submission to see if it is performed as instructed. The performance results are then converted into Award amount which, together with the Merchant ID, Award Program ID and the User ID, are sent to Transaction Engine 105 to authorize a transfer and deposit of the Award amount into the User's Piggy Bank Account at step 515 and step 519. A confirmation message is then sent to the User about the completion of this transaction at step 517.

In reference to FIG. 5B, an in door map service from INDOORALTAS is shown. A merchant may sign up an indoor map service from INDOORALTAS, which provides an API program to the merchant at step 550. The merchant then through the API sends its geo-magnetic fields data information to the INDOORALTAS through a sensor process at step 553, which creates a correlation between the data and an indoor map of the merchants at step 560, then links and cross-maps/indexes such geo-magnetic fields data information to the indoor map of the merchant's store. A user's cell phone or other gadgets that are installed with an INDOORALTAS API program for sensing geo-magnetic field data at the user's location can then obtain the user's location information in the merchant's store through the pre-indexed data and map correlation.

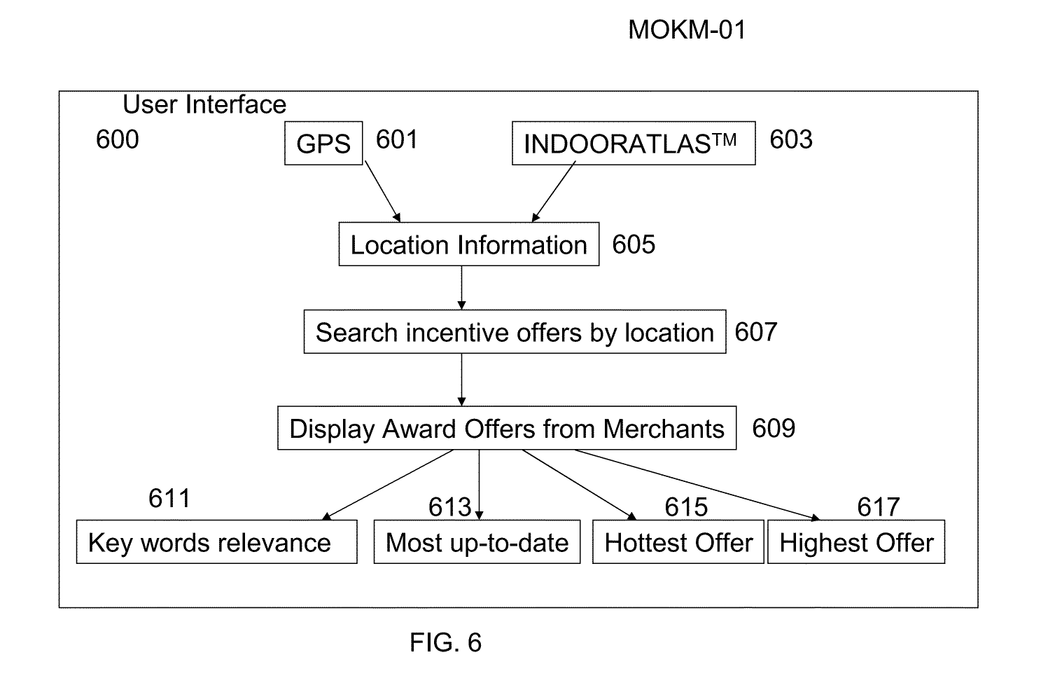

In reference to FIG. 6, an example set of inputs may be input by a user at its User Interface 600. For example, User's GPS location information 601, INDOORATLAS location information 603 can be input automatically or typed into the search box at step 605, and the system then searches the registered Award programs at step 607. The search results of the relevant available Conditional Award Programs are then displayed at step 609. The display may also be arranged according to keywords relevance 611, most up-to-date 613, the hottest program (most popular) 615 or the highest offers 615 or the highest incentives per performance 617 etc.

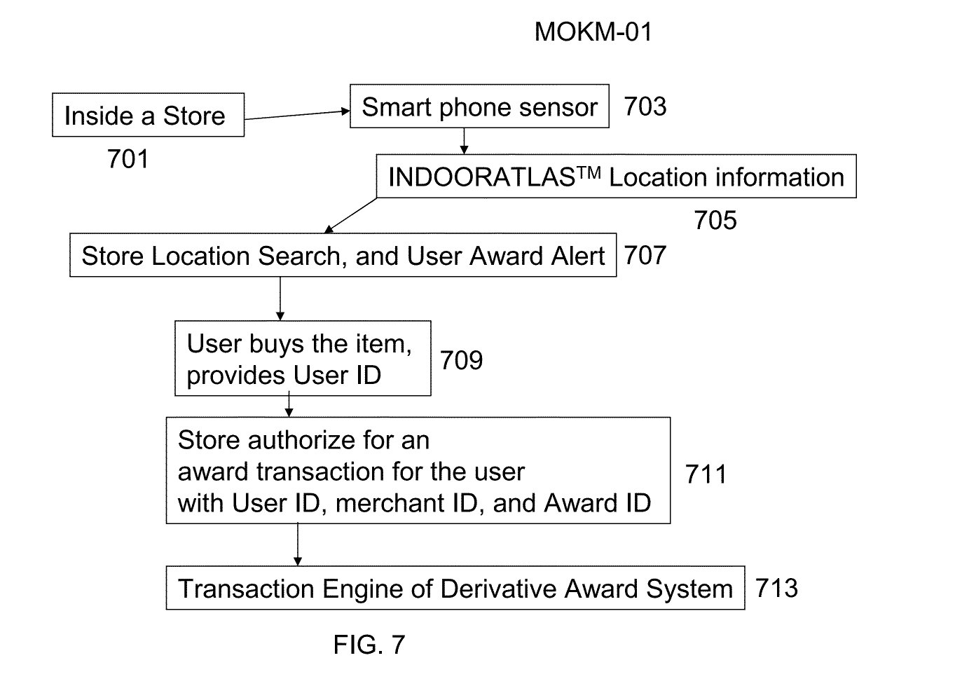

In reference to FIG. 7, if a user is inside a merchant's store at step 701, the user's smart phone or other personal gadget 703 senses the geo-magnetic field of his/her location, and sends it to the INDOORATLAS service at step 705 which sends back the mapped location information back to the user, at step 707, the location information is automatically used for User Award Alert program about a product at the location. The location information may be the aisle numbers in the store or shelf location, compartment location. If the User buys the promoted product at step 709 together with a User ID, the merchant store may authorize an award be transferred to the User's Piggy Bank Account at step 711 through the Transaction Engine 713.

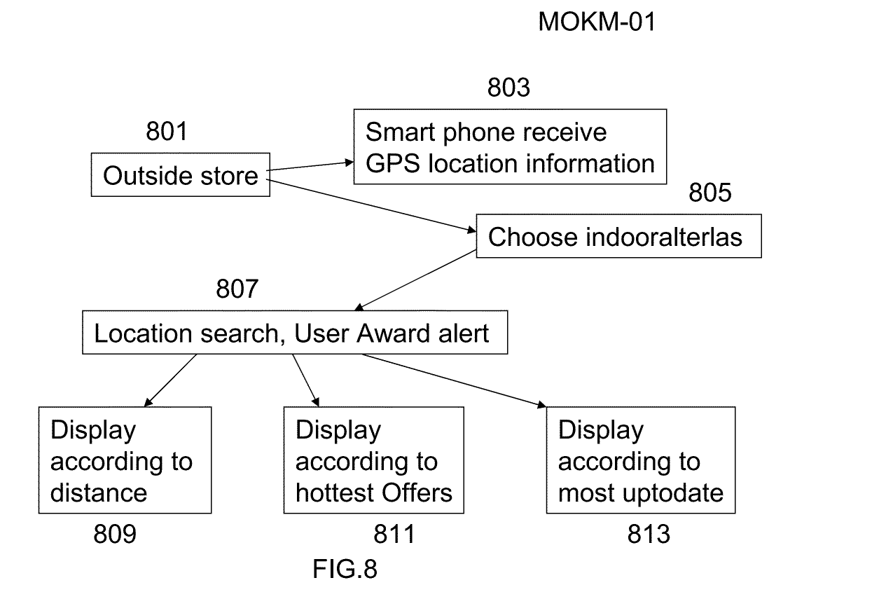

In reference to FIG. 8, if a user is outside any store at step 801, the user's smart phone or other personal gadget receives a GPS location at step 803. The CAS system alternatively allows the user to choose the location information from INDOORALTAS at step 805. The location information is automatically used for User Award Alert program about a product at the location at step 807, and the search results are displayed according to distance at step 809, according to hottest award offers at step 811 and/or the most up to dates offers.

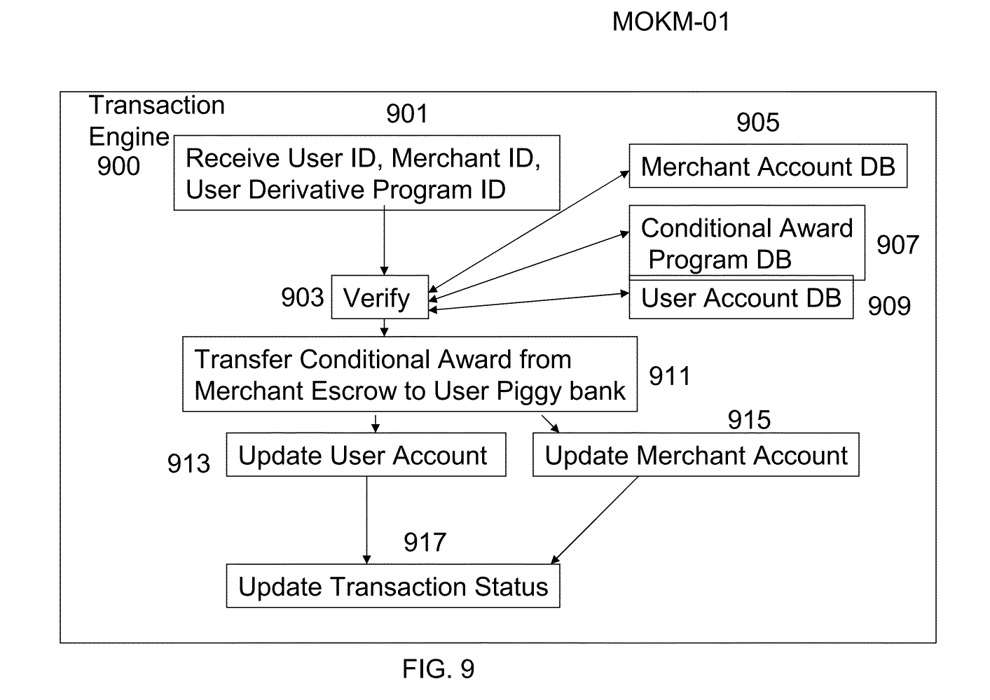

In reference to FIG. 9, an example functional flow chart 900 of Transaction Engine 105 is shown. When the Transaction Engine 105 receives request and an authorization code from a Merchant's User Performance Page, together with a User ID, Merchant ID, Award Program ID and the award amount at step 901, it conducts a verification step at step 903 by accessing Merchant Account Database 905, Conditional Award Database 907, and User Account Database 909. After positive validation, with the authorization code, the Transaction Engine 105 then directly access the Merchant's Escrow Account to transfer the award amount to the User's Piggy Bank Account under the User ID at step 911. Then the User Account 913 and Merchant Account 915 are updated and recorded with this transaction information. Transaction Status is tracked and updated accordingly at step 917.

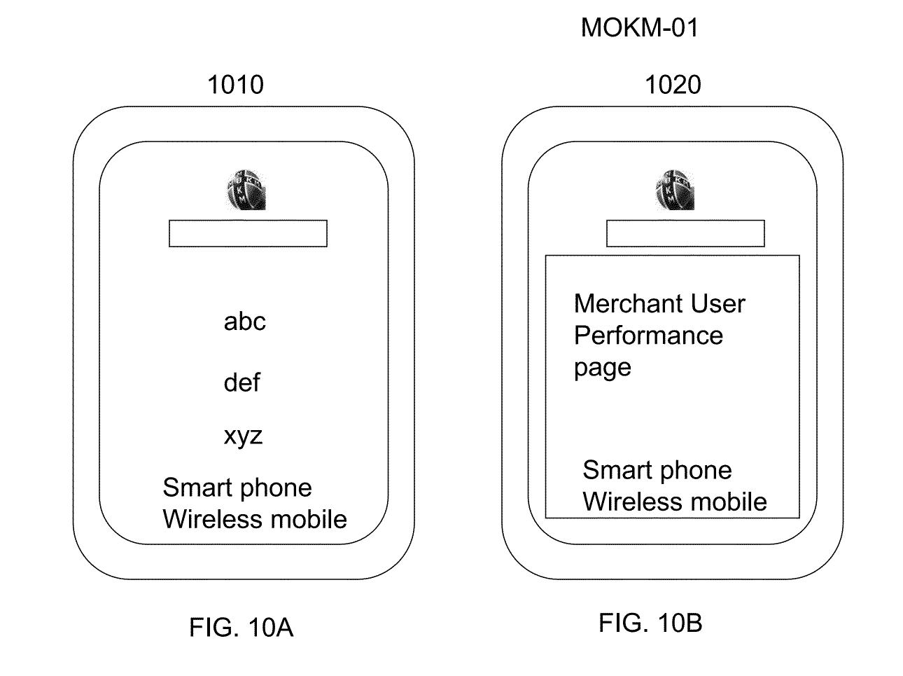

In reference to FIG. 10A, an example CAS interface 1010 for a cell phone. On cell phone, the application Icon is easily located on the top of the phone. With one click on Icon, the application is activated and a search input box is displayed. With the input of keywords, or other information, such as location information, the search results are displayed as hyperlinked listings. One click on one of those hyperlinked listing items, the User is directly shown with the Merchant's User Performance Page with submission buttons as shown in FIG. 10B.

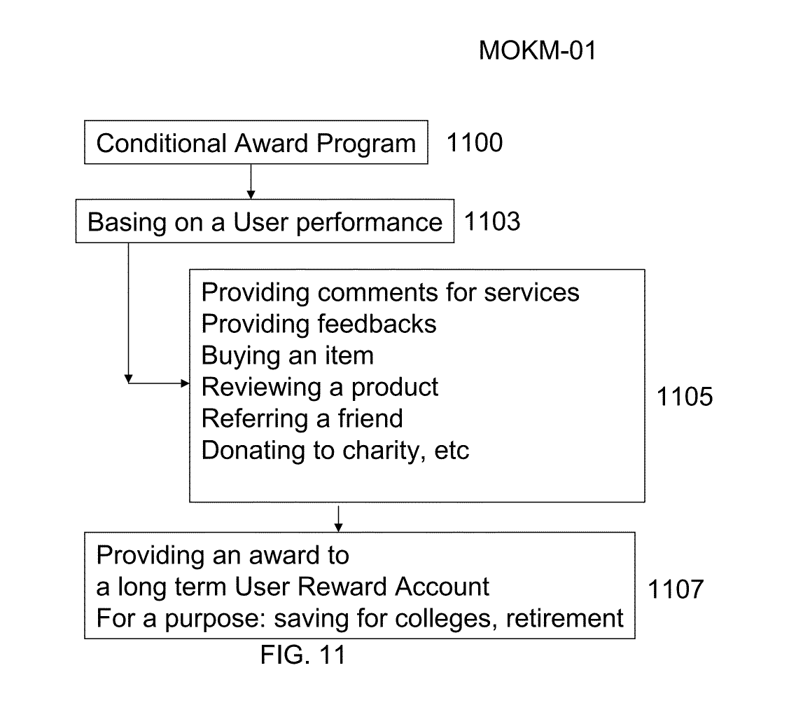

In reference to FIG. 11, an example functional flow chart 1100 for a Conditional Award Program interface is shown. Once a User Performance is submitted, the Transaction Engine 105 enters the functions of the associated Conditional Award Program at step 1103, gathers the results of a user's performance from the Merchant's User Performance page, which may require a User, for example, to provide a feedback, answer a survey, referring a friend, and retrieves the information from the Conditional Award Program Database about the pre-set incentives for these performances at step 1105, then calculates and concludes an award for this performance at 1107.

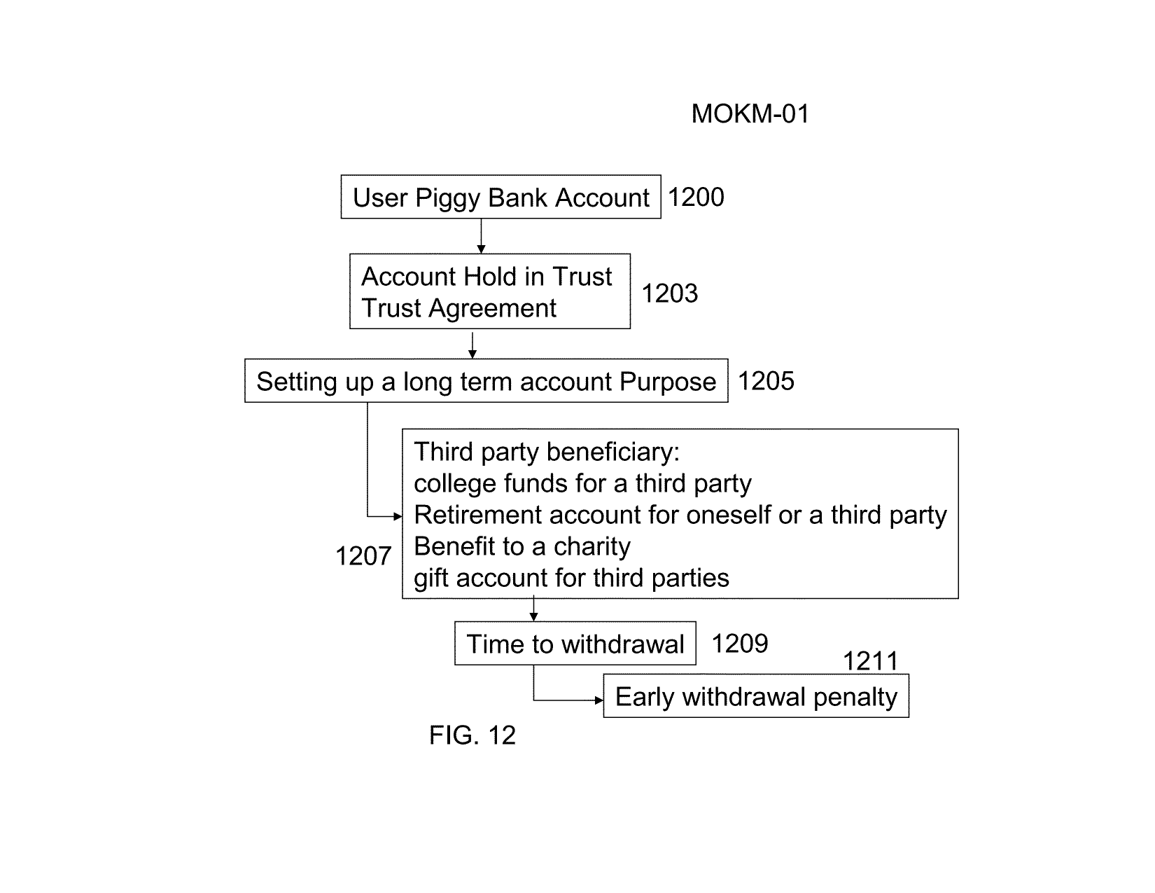

In reference to FIG. 12, an example flow chart 1200 for setting a User Piggy Bank Account is shown. At the User Piggy Bank set up page, a User agrees to the terms on a Trust Agreement at step 1203, and then proceeds to select the long terms goals provided by the system at step 1205. The purported long term use choices may include paying for college educations, a retirement fund, a benefit fund for donating to a charity, an account for a third party beneficiary, providing seed money for starting a business, providing funds for patenting innovations. At step 1209, the length of time for the account to mature is specified, and with the selection of the length of time, a penalty for early withdrawal is also set at step 1211. The penalty may be severe, such as a 10-20% surcharge on the total amount of the account, to encourage a User to stick to its pre-set goal.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A system for providing conditional award to a user, comprising:
a plurality of computer processors, wherein a plurality of modular computer functions are instructed on said computer processors, said plurality of modular computer functions comprising:
a user interface that sends and receives digital data to a Conditional Award System wherein said digital data include a GPS or an INDOORATLAS location information;
a search engine that conducts a search and retrieves information from a merchant Conditional Award Offers Database using said GPS or INDOORATLAS location information; and
a transaction engine that interacts with a merchant account database and a user account database, and performs transactions required to complete a Conditional Award Program.

2. The system of claim 1, wherein said transaction engine further comprises:
a merchant membership processor for creating member accounts for merchants and maintaining a merchant member account database;
a merchant offered-reward processor which processes a reward to a customer from a merchant member and maintains a merchant conditional award offers database wherein said award is rewarded to the customer of the merchant for fulfilling a required customer activity, and said merchant award database being linked with said merchant member account database;
a user membership processor for creating a user member account and maintaining a user member account database, wherein said user member account includes a long term goal-setting account for accumulating rewards; and
a management processor for coordinating and channeling interactions between a merchant account, a user account and/or a system agent.

3. The system of claim 2, wherein said long term goal-setting account has a goal conditioned for being used for college education of a person designated by the user.

4. The system of claim 2, wherein said long term goal-setting account can be withdrawn or redeemed only when set conditions are met, early withdrawal renders a penalty.

5. The system of claim 2, wherein a user can have multiple long term goal-setting accounts and each long term goal-setting account being designated a different beneficiary.

6. The system of claim 2, wherein the system allows a user to create a derivation of rewards which includes options with added value which is changed with time/motive, physical or psychological factors.

7. The system of claim 1, wherein said Conditional Award Program further comprises an option allowing a user to earn reward by promising to purchase or telling friends to purchase a certain product in the future.

8. The system of claim 1, wherein said Conditional Award Program is conditioned on a customer activity about providing an online feedback review of a purchase.

9. The system of claim 2 wherein said long term goal-setting account has a goal conditioned for being used for contribution to a retirement account of a person designated by the user.

10. The system of claim 2, wherein said award includes an hierarchy of structure soliciting a plurality of activities from a customer.

11. The system of claim 2 wherein said customer activity is about submitting an online registration.

12. The system of claim 1 wherein said user interface is a mobile application installed on a user's mobile device.
